(19) United States
(12) Patent Application Publication
(10) Pub. No.: US 2013/0243676 A1
(43) Pub. Date: Sep. 19, 2013

(54) AMINE TREATING PROCESS FOR ACID GAS SEPARATION USING BLENDS OF AMINES AND ALKYLOXYAMINES

(71) Applicants: Michael SISKIN, Westfield, NJ (US); Robert Basil FEDICH, Long Valley, NJ (US); Michel DAAGE, Hellertown, PA (US)

(72) Inventors: Michael SISKIN, Westfield, NJ (US); Robert Basil FEDICH, Long Valley, NJ (US); Michel DAAGE, Hellertown, PA (US)

(73) Assignee: ExxonMobil Research and Engineering Company, Annandale, NJ (US)

(21) Appl. No.: 13/793,212

(22) Filed: Mar. 11, 2013

Related U.S. Application Data
(60) Provisional application No. 61/610,599, filed on Mar. 14, 2012.

(51) Int. Cl. B01D 53/14

(52) U.S. Cl. CPC B01D 53/1462
USPC 423/228

(57) ABSTRACT

A process for absorbing H₂S and CO₂ from a gas mixture containing both these gases comprises contacting the gas mixture with an absorbent combination of (i) primary absorbent component comprising a severely sterically hindered tertiary etheramine triethylene glycol alcohol or derivative of such an alcohol and (ii) secondary absorbent component for acidic gases comprising a liquid amine such as methyldiethylamine (MDEA), monoethanolamine (MEA), 2-amino-2-methyl-1-propanol (AMP), piperazine (PZ), diethanolamine (DEA), triethanolamine (TEA), diglycolamine (aminoethoxyethanol, DGA) and diisopropylamine (DIPA) another etheramine alcohol or diamine. By using the combination of amine absorbents, the overall selectivity of CO₂ pickup can be maintained while retaining good H₂S sorption selectivity; the selectivity of the combination for H₂S and CO2 may be controlled over a range of gas loadings in the absorbent.

### CROSS REFERENCE TO RELATED APPLICATIONS

This application is related to and claims priority benefit under 35 USC 120 from U.S. Patent Application Ser. No. 61/610,599, filed 14 Mar. 2012.

### FIELD OF THE INVENTION

The present invention relates to the absorption of acidic gases from mixed gas streams containing acidic and non-acidic components.

### BACKGROUND OF THE INVENTION

The treatment of gases and liquids containing acidic gases such as CO₂, H₂S, CS₂, HCN, COS and sulfur derivatives of C₁ to C₄ hydrocarbons with amine solutions to remove these acidic gases is well established. The amine usually contacts the acidic gases and the liquids as an aqueous solution containing the amine in an absorber tower with the aqueous amine solution passing in countercurrent to the acidic fluid. In typical cases using common amine sorbents such as monoethanolamine (MEA), diethanolamine (DEA), methyldiethanolamine (MDEA), diisopropylamine (DIPA), or hydroxyethoxyethylamine (DGA). The liquid amine stream contained the sorbed acid gas is typically regenerated by desorption of the sorbed gases in a separate tower with the regenerated amine and the desorbed gases leaving the tower as separate streams. The various gas purification processes which are available are described, for example, in Gas Purification, Fifth Ed., Kohl and Neilsen, Gulf Publishing Company, 1997, ISBN-13: 978-0-88415-220-0.

The treatment of acid gas mixtures containing CO₂ and H₂S with amine solutions typically results in the simultaneous removal of substantial amounts of both the CO₂ and H₂S. It is often desirable, however, to treat acid gas mixtures containing both CO₂ and H₂S so as to remove the H₂S selectively from the mixture, thereby minimizing removal of the CO₂. Selective removal of H₂S results in a relatively high H₂S/CO₂ ratio in the separated acid gas which simplifies the conversion of H₂S to elemental sulfur using the Claus process. Selective H₂S removal is applicable to a number of gas treating operations including treatment of hydrocarbon gases from oil sands, coal and shale pyrolysis, refinery gas and natural gas having a low H₂S/CO₂ ratio and is particularly desirable in the treatment of gases wherein the partial pressure of H₂S is relatively low compared to that of CO₂ because the capacity of an amine to absorb H₂S from the latter type gases is very low. Examples of gases with relatively low partial pressures of H₂S include synthetic gases made by coal gasification, sulfur plant tail gas and low-Joule fuel gases encountered in refineries where heavy residual oil is being thermally converted to lower molecular weight liquids and gases.

Although primary and secondary amines such as MEA, DEA, DPA, and DGA absorb both H₂S and CO₂ gas, they have not proven especially satisfactory for preferential absorption of H₂S to the exclusion of CO₂ because in aqueous solution, the amines undergo more selective reaction with CO₂ to form carbamates. The tertiary amine, MDEA, has been reported to have a high degree of selectivity toward H₂S absorption over CO₂ (Frazier and Kohl, Ind. and Eng. Chem., 42, 2288 (1950)), but its commercial utility is limited because of its restricted capacity for H₂S loading and its limited ability to reduce the CO₂ content of the gas. Similarly, diisopropylamine (DIPA) is relatively unique among secondary amino alcohols in that it has been used industrially, alone or with a physical solvent such as sulfolane, for selective removal of H₂S from gases containing H₂S and CO₂, but contact times must be kept relatively short to take advantage of the faster reaction of H₂S with the amine compared to the rate of CO₂ reaction. This greater selectivity was attributed to the relatively slow chemical reaction of CO₂ with tertiary amines as compared to the more rapid chemical reaction of H₂S.

A number of severely sterically hindered etheramine compounds have been developed for the selective removal of H₂S in the presence of CO₂. U.S. Pat. Nos. 4,405,581; 4,405,583; 4,405,585; 4,471,138 and 4,894,178 disclose these highly effective hindered selective absorbents. The following typical types of absorbent are disclosed in these patents to which reference is made for a full description of these materials and their use in acidic gas sorption processes:

U.S. Pat. No. 4,405,581: The hindered aminoalcohol compounds disclosed in this patent are defined by the formula:

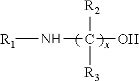

where R¹ is usually a C₁-C₈ alkyl group such as tertiary butyl, secondary-butyl, isopropyl, tertiary-amyl or cyclohexyl, R² and R³ are usually hydrogen, or C₁-C₄ alkyl groups, with the certain provisos to define the adequately hindered molecule, x is an integer from 2 to 4, i.e., the aminoalcohols can be regarded as hindered aminated derivatives of ethylene glycol, propylene glycol or butylene glycol. Specific non-limiting examples of the severely sterically hindered secondary amino alcohols of this type include tertiarybutylaminoethanol, 2-(tertiarybutylamino)-1-propanol, 2-(isopropylamino)-propanol, 3-(tertiarybutylamino)-n-butanol, 3-(tertiarybutylamino)-1-propanol and 3-aza-2,2-dimethyl-1,6-hexanediol.

U.S. Pat. No. 4,405,583: The hindered diamino etheramines disclosed in this patent are defined by the formula:

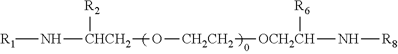

where R¹ and R⁸ are C₃-C₈ secondary alkyl or secondary hydroxyalkyl, or C₄-C₈ tertiary alkyl or tertiary hydroxyalkyl radicals, R² and R⁶ are each hydrogen or C₁-C₄ alkyl, with the proviso that when R¹ and R⁸ are secondary alkyl, R² and R⁶ are C₁-C₄ alkyl radicals, and 0 is either zero or a positive integer ranging from 1 to 4. Representative di-secondary etheramines include, for example, bis-(tertiarybutylaminoethyl)ether; 1,2-bis(tertiarybutylaminoethoxy) ethane; 1,2-bis-(tertiarybutylaminoethoxyethoxy) ethane; bis[2-(iso-propylamino)propyl)ether and 1,2-[2-(isopropylamino)-propoxy]ethane.

U.S. Pat. No. 4,405,585: This patent discloses the selective removal of H₂S from acidic gas mixtures using severely sterically hindered secondary etheramine alcohols for including those defined by the general formula:

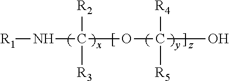

where R¹ is primary C₁-C₈ alkyl or primary C₂-C₈ hydroxyalkyl branched chain alkyl or other selected groups; R², R³, R⁴ and R⁵ are each independently hydrogen, C₁-C₄ alkyl or C₁-C₄ hydroxyalkyl, with the proviso that when R¹ is primary alkyl or hydroxyalkyl, both R² and R³ bonded to the carbon atom directly bonded to the nitrogen atom are alkyl or hydroxyalkyl and that when the carbon atom of R¹ directly bonded to the nitrogen atom is secondary at least one of R² or R³ bonded to the carbon atom directly bonded to the nitrogen atom is an alkyl or hydroxyalkyl, x and y are each positive integers independently ranging from 2 to 4 and z is a positive integer ranging from 1 to 4. Specific etheramine alcohols whose use is comprehended by this patent include:

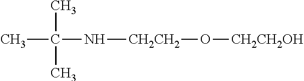

Tertiarybutylaminoethoxyethanol

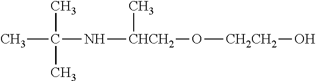

2-(2-tertiarybutylamino)propoxyethanol

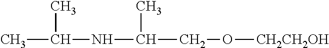

(1-methyl-1-ethyl propylamino)ethoxyethanol

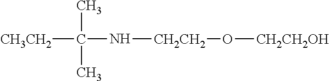

2-(2-isopropylamino)propoxyethanol

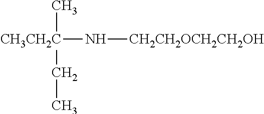

Tertiaryamylaminoethoxyethanol

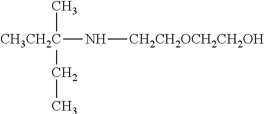

(1-methyl-1-ethylpropylamino)ethoxyethanol

U.S. Pat. No. 4,471,138 is directed to a class of selective H₂S absorbents which are secondary tertiary and etheramine alcohols of the formula:

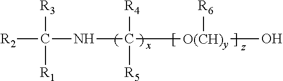

where:

R¹=R²=R³=CH₃; R⁴=R⁵=R⁶=H; R¹=R²=R³=CH³; R⁴=H or CH₃; R⁵=R⁶=H;

R¹=R²=R³=R⁶=CH₃; R⁴=R⁵=H; R¹=R²=R³=CH₃CH₂; R⁴=R⁵=R⁶=H; or

R¹≠R²≠R³=H, CH₃, CH₃CH₂, R⁴≠R⁵≠R⁶=H or CH₃, and x=2-3.

U.S. Pat. No. 4,894,178: This patent discloses the selective H₂S absorbents which are a mixture of a severely hindered tertiary dietheramine with a severely hindered tertiary etheramine alcohol with the formulae:

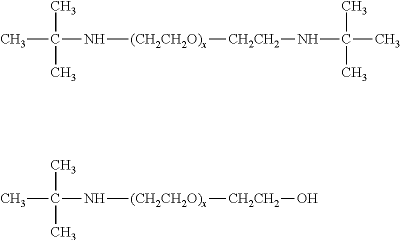

with x being an integer from 2 to 6 and the weight ratio of the first amine to the aminoalcohol ranging from 0.43:1 to 2.3:1. The preferred absorbent is a combination of bis-(tert.-butylaminoethoxy) ethane (BTEE) and ethoxyethoxyethanol-tert.-butylamine (EEETB). These mixtures can be prepared in a one-step synthesis, by the catalytic tertiary butylamination of the polyalkenyl ether glycol, HO—(CH₂CH₂O)-x-CH₂CH₂—OH. For example, the mixture of BTEE and EEETB can be obtained by the catalytic tertiarybutylamination of triethylene glycol. The severely hindered amine mixture, e.g., BTEE/EEETB, in aqueous solution can be used for the selective removal of H₂S in the presence of CO₂.

U.S. 2010/0037775 discloses alkylamine alkyloxy alkyl ethers which are selective for the sorption of H₂S from acidic gas mixtures containg CO₂. The sorbents are produced by the reaction of an alkyloxy alcohol with a hindered primary alkylamine such as tert-butylamine.

US 2009/0308248 describes a different class of absorbents which are selective for H₂S removal in the presence of CO₂, the hindered amino alkyl sulfonate, sulfate and phosphonate salts, with the sulfonate and phosphonates being the preferred species. The formula of these compounds is:

R¹R²N—(—CR³R⁴—)ₙ—X

where R¹, R², R³ and R⁴ are typically hydrogen, C₁-C₉ substituted or unsubstituted alkyl, C₆-C₉ aryl provided both R¹ and R² are not hydrogen; and wherein when n is 2 or more, R³ and R⁴ on adjacent carbon or on carbons separated by one or more carbons can be a cycloalkyl or aryl ring and wherein, when substituted, the substituents are heteroatom containing substituents, and n is an integer of 1 or more, and X is a metal salt group, such as —SO₃⁻, —SOS₃⁻, —NHSO₃⁻, —PO₃²⁻, —PO₃H⁻, —OPO₃²⁻, —NHPO₃²⁻ or —CO₂⁻ where the valence(s) of the salt group are satisfied by a metal cation such as sodium or potassium. Preferred absorbents of this type include sodium tert-butylaminomethylsulfonate; sodium 2-(tert-butylamino) ethylsulfonate; sodium 3-(tert-butylamino)propylsulfonate; diethyl tert-butylaminomethylphosphonate and disodium tert-butylaminomethylphosphonate.

Proposals have been made for using selective amine absorbents in combination with other materials affecting the sorption properties. U.S. Pat. No. 4,892,674, for example, discloses a process for the selective removal of H₂S from gaseous streams using an absorbent composition comprising a non-hindered amine and an additive of a severely-hindered amine salt and/or a severely-hindered aminoacid. The amine salt is the reaction product of an alkaline severely hindered amino compound and a strong acid or a thermally decomposable salt of a strong acid, i.e., ammonium salt.

The potential of using amine blends was disclosed by Lunsford et al in Optimization of Amine Sweetening Units, Proc. 1996 AlChE Spring National Meeting, New York, N.Y., which showed that a blend of MDEA in a 30% DEA solution, increased CO₂ take up. The use of physical solvents such as sulfolane with MDEAS or DIPOA is also reported to increase removal of species such as COS and mercaptans.

### SUMMARY OF THE INVENTION

While the severely hindered etheramine alcohols and their derivatives such as the alkoxy derivatives of US 2010/003775 have excellent selectivity for H₂S in acidic gas mixtures which also contain CO₂, there are occasions when it is desired to absorb both H₂S and CO₂, for example, to remove CO₂ from natural gas which comes from wells with a high CO₂ content where it is desired to re-inject the CO₂ for pressure maintenance and for carbon sequestration but where it is also necessary to meet maximum H₂S specifications for pipelining, e.g. with gas from fields such as LaBarge, Wyo. In these cases, the overall selectivity of CO₂ pickup may need to be optimized when maximum selectivity is not required.

We have now found that the overall selectivity of CO₂ pickup can be secured while maintaining good H₂S sorption selectivity by carrying out the absorption with a severely hindered tertiary alkyletheramine alcohol derived from triethylene glycol in combination with a secondary absorbent amine component such as methyldiethylamine (MDEA), monoethanolamine (MEA), 2-amino-2-methyl-1-propanol (AMP), piperazine (PZ), diethanolamine (DEA), triethanolamine (TEA), diglycolamine (aminoethoxyethanol, DGA) and diisopropylamine (DIPA) or one or more of the alkyletheramines.

According to the present invention, the process for absorbing H₂S and CO₂ from a gas mixture containing both these gases comprises contacting the gas mixture with an absorbent combination of (i) a primary absorbent component which comprises a severely sterically hindered tertiary alkyletheramine, and (ii) a secondary absorbent component which comprises an amine absorbent for acidic gases. The absorbent combination of the primary and secondary components will normally be used in the form of a liquid absorbent solution, typically an aqueous solution. While the ability to absorb both H₂S and CO₂ is useful in certain circumstances as noted above, improved H₂S selectivity is also useful asset as is the capability of loading (moles of absorbed gas per mole of amine) and the capacity (moles of gas absorbed by solution relative to the moles desorbed from the solution, that is the relative amount absorbed and released in each absorption/desorption cycle). For this purpose, combinations of etheramine compounds have been found to be advantageous as described in more detail below.

### DRAWINGS

In the accompanying drawings:

FIG. 1 is a graph showing the H₂S selectivity at different total gas loadings (H₂S plus CO₂) with different etheramine mixtures.

FIG. 2 is a graph showing the H₂S selectivity at different times with different ethoxyamine mixtures.

FIG. 3 is a graph showing the H₂S selectivity of a preferred etheramine mixture in comparison with individual etheramines.

### DETAILED DESCRIPTION

### Glossary of Abbreviations

In order to facilitate understanding of various abbreviations of the compounds that may be named in the specification, the following glossary is provided:
DEG Diethylene glycol
TEG Triethylene glycol
TBA Tertiary-butyl amine
MAE Methylaminoethanol
EEA Ethoxyethanolamine
EETB Ethoxyethanol-t-butylamine (tertiary-butyl-ethoxyethanol)
EEETB EthoxyEETB (Ethoxyethoxyethanol-t-butylamine)
DEGM Diethylene glycol monomethyl ether
TEGM Triethylene glycol monomethyl ether
MDEGTB Diethylene glycol t-butylamine monoethyl ether
MEETB MethoxyEETB (methoxy ethoxyethoxyethanol-t-butylamine)
BEETB ButoxyEETB
TEGTB Triethylene glycol-t-butylamine (ethoxyethoxyethanol-t-butylamine or t-butylamino-ethoxyethoxyethanol)
MEEETB MethoxyTEGTB (methoxyethoxyethoxyethanol-tert-butylamine or t-butylamino-ethoxyethoxyethyl methyl ether)
Bis-SE Bis-(t-butylamino)-DEG
Bis-TEGTB Bis-(t-butylamino)-TEG (TEG(TB)₂)
DEGTB Diethylene glycol-t-butylamine (ethoxyethanol-t-butylamine or t-butylamino-ethoxyethanol)
Bis-DEGTB Bis-(t-butylamino)-DEG (DEG(TB)₂)

### Primary Absorbent Component—Severely Hindered Etheramine Absorbent

The preferred severely sterically hindered etheramine derivatives described below are preferably derived from triethylene glycol (TEG) although derivatives of diethylene glycol (DEG) as well as other etheramines particularly the polyglycolamines may also be found suitable. Thus, while any of the severely hindered amino derivatives described above may be used in combination with one or more of the more conventional amine absorbents, the TEG derivatives form a preferred class in view of their high selectivity for H₂S absorption and absorption capacity which can then be balanced against the CO₂ absorption of the conventional amine.

In general, the preferred etheramine derivatives are made by the reaction of triethylene glycol (TEG) with a severely hindered amine which may be a primary or secondary amine. The preferred amines for reaction with the TEG are primary amines with a tertiary alkyl group, especially C3-C8 alkyl, to form secondary or tertiary amino derivatives of the glycol. Tertiary butyl is the preferred tertiary alkyl group. As derivatives of triethylene glycol (TEG), the severely hindered etheramineetheramines of the present process will have the characteristic group derived from this glycol:

—(CH₂CH₂—O—)₃—

Diethylene glycol derivatives will contain the characteristic grouping:

—(CH₂CH₂—O—)₂—

Various groups will be attached at the two ends of the polyglycol chain. For example, according to a first variant, secondary or tertiary amino groups may be attached at each end of the TEG moiety to form a dietheramine according to the preferred formula given in U.S. Pat. No. 4,405,583:

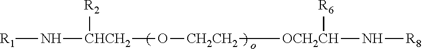

where R¹ and R⁸ are each C₃ to C₈ secondary alkyl or hydroxyalkyl or C₄ to C₈ tertiary alkyl or hydroxyalkyl groups, R² and R⁶ are each hydrogen, and where, in this case, o is 1. Representative di-alkyletheramines derivatives of TEG of this type include, for example, 1,2-bis-(tertiarybutylaminoethoxy) ethane.

Alternatively, following the formula of U.S. Pat. No. 4,405,585, the TEG derivatives may be etheramine alcohols of the formula:

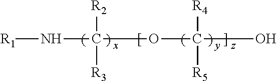

where R², R³, R⁴ and R⁵ are H, R¹ is C₃-C₈ branched chain alkyl, preferably tertiary alkyl, e.g., tert.-butyl, x and y are each 2 and z is 2 (z is 1 for the corresponding DEG derivatives). An example of such an absorbent is ethoxyethoxyethanol-tert.-butylamine (EEETB) which, as described in U.S. Pat. No. 4,894,178, is preferably used in combination with the DEG derived diamino ethers of U.S. Pat. No. 4,405,583, for example, 1,2-bis(tert.-butylaminoethoxy)ethane (BTEE), with a preferred ratio of the two components being in the weight ratio of 0.43:1 to 2.3:1.

TEG derivatives following the general formula of U.S. Pat. No. 4,471,138 may also be blended with conventional amine absorbents; in this case, the TEG derivatives will adhere to the formula:

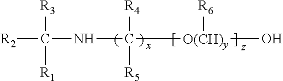

where R¹=R²=R³=C₁-C₄ alkyl, preferably CH₃; R⁴=R⁵=R⁶=H; x=y=2 and z=2. The corresponding DEG derivatives are formed when z=1.

If an alkoxy-capped TEG is reacted with the severely hindered amine to result in a hindered alkylamine alkoxy (alcohol) monoalkyl ether according to the reaction scheme set out in US 201/0037775, the starting alkoxy alcohol will be an alkoxy-triethylene glycol and the alkylamine will typically be a sterically hindered amine of the formula R²R⁵NH where R² is C₃-C₆ alkyl, preferably C₃-C₆ branched chain alkyl, R⁵ is H or C₁-C₆ alkyl; the preferred amine is tert-butylamine.

When the TEG derivative is an alcohol, e.g., an etheramine alcohol such as EEETB, the hydroxyl group may be esterified with a lower carboxylic acid (C₂-C₆) to yield a etheramine ester such as 2-(ethoxyethoxy-tert.-butylamino) ethyl acetate, propionate or butyrate which may then be used as a component in the blend with the other amine. The hydroxyl group may, alternatively, be converted to an ether group by reaction with an lower (C₁-C₄) alkyl halide

When the TEG etheramine has more than one amino group, improved solubility in water may be conferred by conversion of one of the amino groups to their corresponding aminosulfonate or aminophosphonate salts by reaction with the appropriate sulfonic acid or phosphonic acid although at the expense of decreased loading capacity for the acidic gases as the reacted amino group becomes inactive for acid gas removal.

### Secondary Absorbent Components

The amine absorbents which are used as the secondary absorbent component in combination with the primary (hindered etheramine) absorbents comprise the amines which are effective for chemisorbing CO₂. In this way, the relative sorption properties of the absorbent solution may be balanced between the H₂S and CO₂ contents of the incoming gas stream so that the desired removal of each gas is obtained. As described below, the secondary absorbent component may be one or more etheramines. In general, the weight ratio of the two components of the blend may typically vary between 5:95 to 95:5, or over a more limited range from 10:90 to 90:10, more usually from 20:80 to 80:20 and in some cases an approximately equal weight of each in the absorbent solution, e.g. from 40:60 to 60:40.

Amines such as the ethanolamines, e.g., monoethanolamine (MEA), diethanolamine (DEA), triethanolamine, (TEA), methylaminoethanol (MAE) and ethoxyethylamine (EEA), methyldiethanolamine (MDEA), or hydroxyethoxyethylamine (diglycolamine, DGA), as well as other amines such as piperazine (PZ), diisopropylamine (DIPA), are all likely to be found useful as the secondary component in blends with the hindered etheramine absorbents. The preferred blends are, however, blends of etheramine compounds including EETB/MEETB, EEETB/MEETB, EETB/MEEETB, EEETB/MEEETB, EEETB/EEE(TB)₂. The blends may include blends of dietheramines such as TEG(TB)₂ with DEG(TB)₂, blends of aminoalcohols with other aminoalcohols such as EETB with EEETB, EETB with MEETB, EETB with MEEETB and blends of aminoether alcohols with diamino etheramines such as TEGTB with TEG(TB)₂, DEGTB with DEG(TB)₂ etc.

The blended absorbent combination will typically be used in the form of an aqueous solution in the absorption process, normally at a concentration from 5 to 40 wt. percent total amine with most processing carried out at 5-30 wt. percent. Physical solvents (as opposed to the amino compounds which are chemical absorbents) may also be used. Solvents which are physical absorbents are described, for example, in U.S. Pat. No. 4,112,051, to which reference is made for a description of them; they include, for example, aliphatic acid amides, ethers, esters such as propylene carbonate, N-alkylated pyrrolidones such as N-methyl-pyrrolidone, sulfones such as sulfolane, sulfoxides such as DMSO, glycols and their mono- and diethers such as glyme. The preferred physical absorbents are the sulfones, most particularly, sulfolane. These physical solvents may also be used in combination with water. If the solvent system is a mixture of water and a physical absorbent, the typical effective amount of the physical absorbent employed may vary from 0.1 to 6 moles per litre of total solution, and preferably from 0.5 to 3 moles per litre, depending mainly on the type of amino compound being utilized.

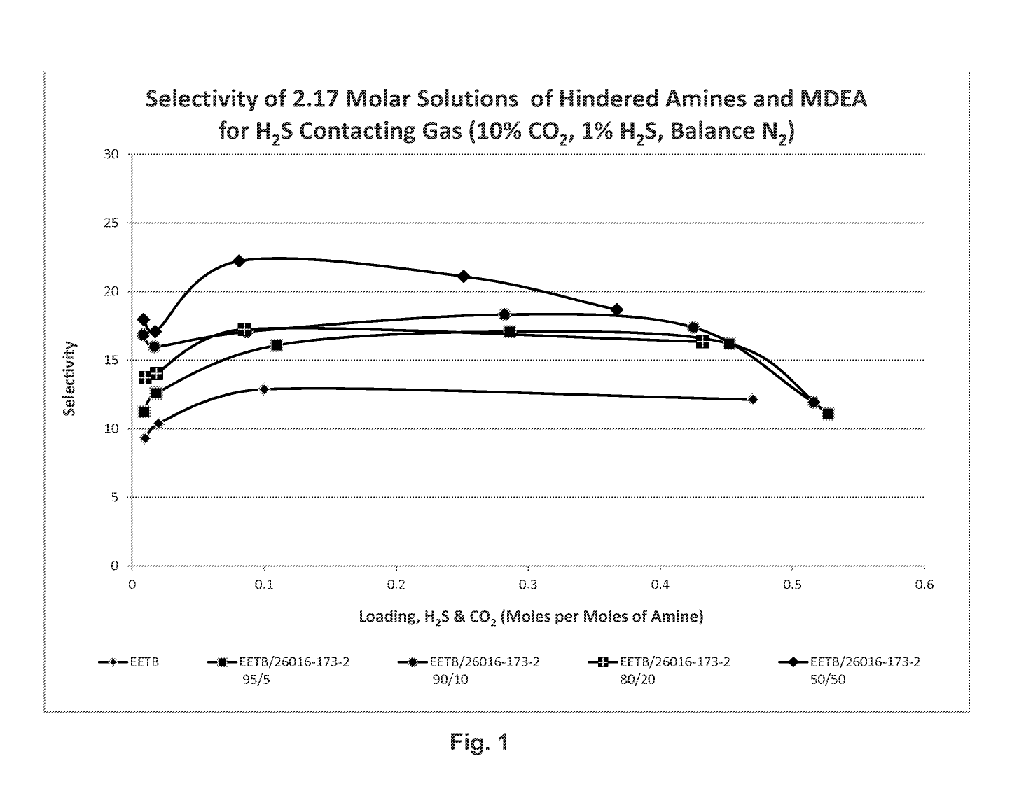

The primary and secondary absorbent components may be used together over a wide range of ratios. As shown below, the addition of only a minor amount of a second absorbent is capable of effecting a significant change in the H₂S selectivity. For example, the addition of just 5% MEEETB to EETB boosts the selectivity by approximately 5 percentage points over a broad range of total loadings (H₂S plus CO₂) up to about 5% (total moles per mole of amine). The use of a 50/50 mixture of EETB and MEEETB may boost H₂S selectivity by about 8 to 10 percentage points over the same range, as shown in FIG. 1 below. The two components of the blend may therefore be used over a wide range of molar ratios typically extending from 95:5 to 5:95, e.g., from 90:10 to 10:90, from 80:20 to 20:80, from 25:75 to 75:25, 606:40 to 40:60 and in approximately equal molar proportions.

Processing of the acidic gas stream will follow the normal lines of an amine absorption process using an aqueous absorbent solution, usually in a cyclic absorption-regeneration unit of the type described in U.S. Pat. No. 4,471,138; 4,894,178 or 4,405,585, as referenced above.

The absorbent solution may include a variety of additives typically employed in selective gas removal processes, e.g., antifoaming agents, anti-oxidants, corrosion inhibitors, and the like. The amount of these additives will typically be in the range that they are effective, i.e., an effective amount.

One advantage of the triethylene glycol selective absorbents is that they may be readily mixed with the secondary absorbent component including the conventional amine absorbents such as MDEA, DEA, etc. as well as other etheramines in all proportions. A gas processing unit filled with a conventional amine absorbent can therefore be converted to operation with one of the triethylene glycol absorbents by simply topping up the unit with the triethylene glycol absorbent to replace losses of the conventional amine as they occur. Alternatively, a portion of the conventional amine may be withdrawn and replaced by the triethylene glycol derivative if a greater degree of selectivity for H₂S is desired, for example, by a change in the composition of the feed or a requirement to increase the selectivity.

The absorbent solution ordinarily has a concentration of amino compound of about 0.1 to 6 moles per liter of the total solution, and preferably 1 to 4 moles per liter, depending primarily on the specific amino compound employed and the solvent system utilized.

### Example 1

Mixtures of two etheramines, t-butylaminoethoxyethanol (EETB) and methoxy-triethylene glycol-t-butylamine (MEEETB, t-butylamino-ethoxyethoxyethyl methyl ether) in varying ratios were tested for their absorption characteristics by bubbling a gas mixture containing 10% v/v CO₂, 1% H₂S, balance N₂, through a stirred 2.17 molar aqueous amine mixture at 40° C. (absorbent and gas), 138 kPag (20 psig) at a gas flow rate of 600 mL/min. The five gas ratios tested were (EETB/MEEETB): 100/0; 95:5; 90/10; 80/20 and 50:50.

The gas was introduced into the solvent solution down a dip tube with the outlet submerged just below (8 mm) the surface of the solvent. These parameters were found to provide stable and repeatable data for both MDEA and other solutions. The test gas was water saturated before entering the test cell. A variable speed paddle mixer circulated solvent past the dip tube at a controlled rate. The cell was run at atmospheric pressure. Gas venting from the cell was passed through a collection pot where it was sampled and analyzed for H₂S and CO₂ concentration. using a GASTEC™ stain tube (colorimetric quantification).

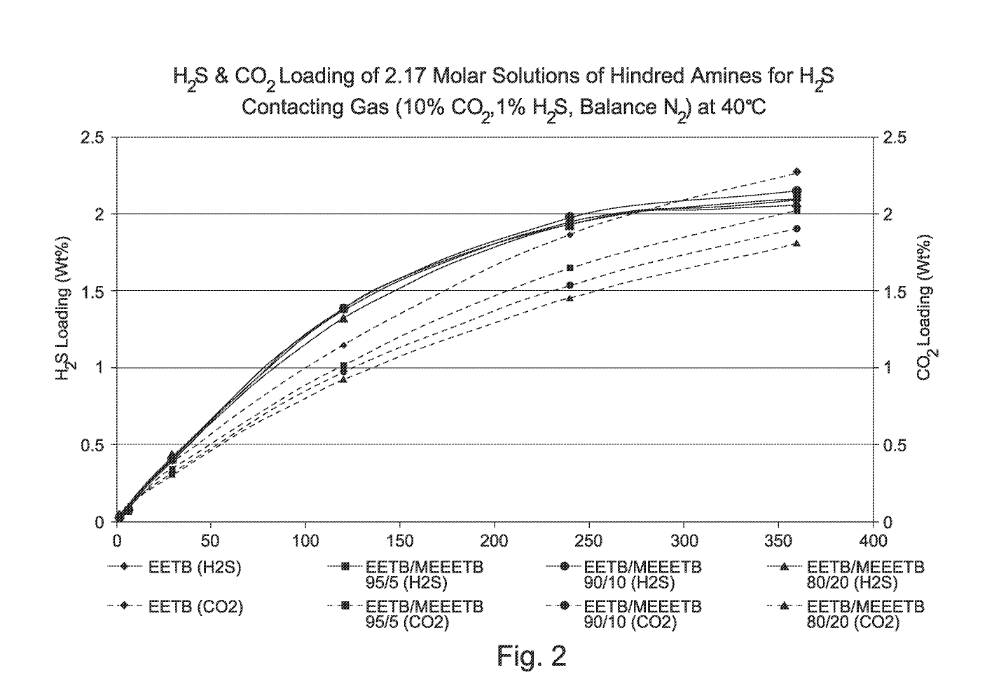

The selectivities of the mixtures were calculated as the ratio of H₂S and CO₂ absorbed in the solution to the H₂S and CO₂ in the feed gas (moles/moles). FIG. 1 shows that the addition of the MEEETB at quite low fractions of the overall composition makes a significant difference in the H₂S selectivity with the greatest increase in selectivity at loadings up to about 0.35 moles per mole of amine being achieved with 50/50 mix. FIG. 2 shows that the MEEETB appears to enhance selectivity through accelerated H₂S absorption compared with the EETB base case rather than through inhibiting CO₂ pickup, implying that optimal gas/liquid contact times for H₂S selectivity will be lower than those needed for maximal absorption (loading).

### Example 2

Further studies with etheramines and blends of etheramines carried out in the same manner showed that the blends possessed potential advantages in H2S selectivity and loading in comparison with single etheramines, as shown by Table 1 below:

TABLE 1

| | | | Loading | Capacity | Selectivity- |
|---|---|---|---|---|---|
| Compound | Mol. Wt. | Selectivity | (%) | (%) | Reabsorption |
| EETB | 161.24 | 14.5 | 17.4 | 61.0 | 15.3 |
| Bis-SE | 216.36 | 16.76 | 28.2 | 80.0 | 25.2 |
| MEEETB | 219.32 | 64.4 | 24.2 | 98.4 | 69.7 |
| TEG(TB)₂ | 260.42 | 23.3 | 19.4 | 65.1 | 39.2 |
| TEGTB | 205.26/ | 128.2 | 45.4 | 82.6 | 131.2 |
| (32.2%)/ | 260.42 | | | | |
| TEG(TB)2 | | | | | |
| (67.4%) | | | | | |

Bis-SE = Bis-(t-butylamino)-diethylene glycol
TEGTB = Triethylene glycol-t-butylamine
TEG(TB)₂ = Bis-(t-butylamino)-triethylene glycol
Loading = Moles of H₂S/Moles of absorbent
Capacity = Moles of H₂S absorbed by solution/Moles of H₂S after desorption from solution.

Thus, even though the mixture of TEGTB and TEG(TB)₂ has a molecular weight disadvantage (weighted average mol. wt of 241.61) compared to MEEETB (219.32) resulting in fewer moles of absorbent per unit weight purchased, the increased H₂S selectivity and loading resulting from the two reaction sites on the two amine groups, approximately double that of the MEEETB, makes the use of the blend attractive since the capital and operating costs of the unit will be substantially reduced. Further, the selectivity, loading and other performance parameters for the blend are also greatly better than those of the bis-(amino) compound on its own.

### Example 3

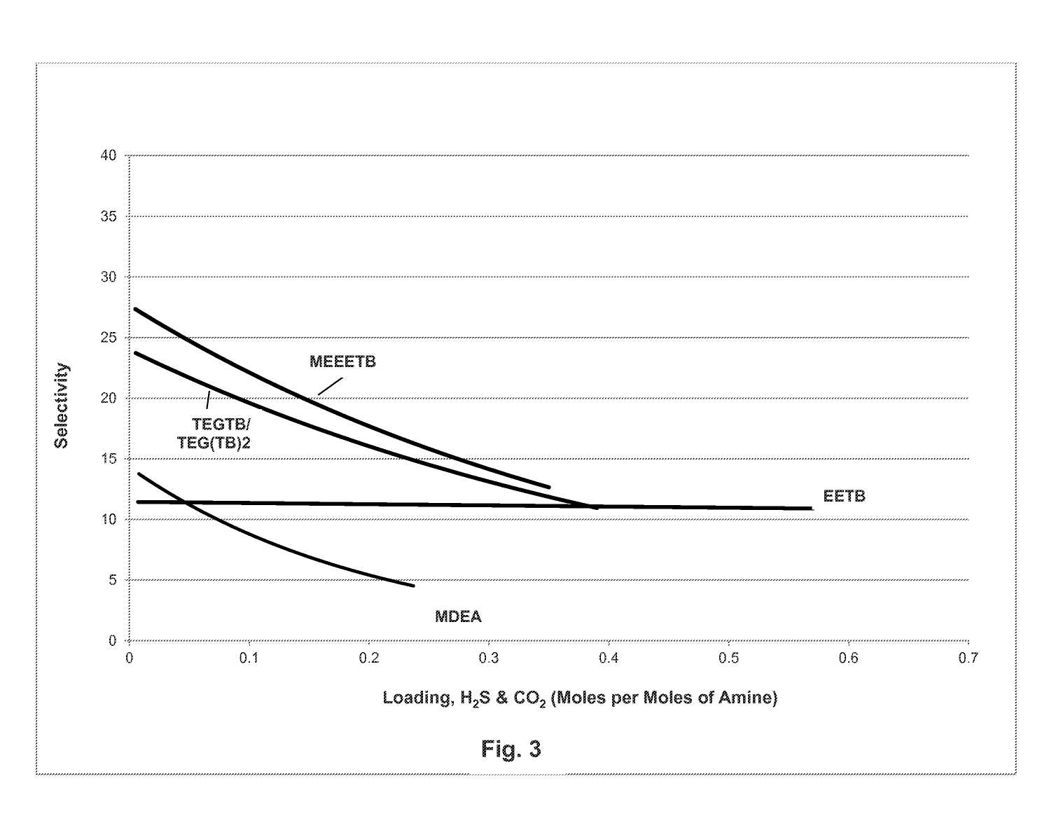

The evaluation was continued by the same method using MDEA, EETB, MEEETB and a mixture of TEGTB and TEG(TB)₂ (57.8%/35% with unreacted TEG as balance) to show the relationship of H₂S selectivity with over a range of loadings. The results are shown in FIG. 3. MDEA is approximately as selective as EETB but only at very low loadings after which the selectivity becomes sharply worse at higher rates. EETB has the virtue of having a linear selectivity at all loadings. MEEETB and the TEG blend are significantly more selective than EETB at low to moderate loadings with MEETB having a marginal advantage but given the doubling in loading afforded by the bis-(amino) derivative in the mixture (see Example 2), the blend has a clear advantage in selectivity over the other material.

1. A process for absorbing H₂S and CO₂ from a gas mixture containing both these gases comprises contacting the gas mixture with an absorbent combination of (i) a primary absorbent component which comprises a severely sterically hindered tertiary alkyletheramine triethylene glycol alcohol or derivative of such an alcohol and (ii) a secondary absorbent component which comprises an amine absorbent for acidic gases.

2. A process according to claim 1 in which the secondary absorbent component for acidic gases comprises methyldiethylamine (MDEA), monoethanolamine (MEA), methylaminoethanol (MAE), ethoxyethanolamine (EEA), 2-amino-2-methyl-1-propanol (AMP), piperazine (PZ), diethanolamine (DEA), triethanolamine (TEA), diglycolamine (aminoethoxyethanol, DGA) or diisopropylamine (DIPA).

3. A process according to claim 1 in which the absorbent combination comprises a mixture of etheramine compounds.

4. A process according to claim 1 in which the absorbent combination comprises a mixture of an etheramine alcohol and a dietheramine.

5. A process according to claim 1 in which the absorbent combination comprises a mixture of dietheramines.

6. A process according to claim 1 in which the absorbent combination comprises a mixture of etheramine alcohols.

7. A process according to claim 1 in which the primary absorbent component comprises a severely sterically hindered diamino etheramine derivative of triethylene glycol of the formula: 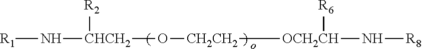
where R¹ and R⁸ are C₃-C₈ secondary alkyl or secondary hydroxyalkyl, or C₄-C₈ tertiary alkyl or tertiary hydroxyalkyl groups, R² and R⁶ are each hydrogen, and o is 1.

8. A process according to claim 7 in which R¹ and R⁸ are C₄-C₈ tertiary alkyl groups.

9. A process according to claim 7 in which the primary absorbent component comprises 1,2-bis(tertiarybutylaminoethoxy) ethane.

10. A process according to claim 1 in which the primary liquid amine absorbent comprises an etheraminealcohol of the formula: 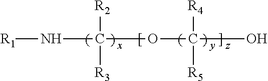
where R², R³, R⁴ and R⁵ are H, R¹ is C3-C8 branched chain alkyl, x and y are each 2 and z is 2.

11. A process according to claim 10 in which R¹ is tert.-butyl.

12. A process according to claim 10 in which the primary absorbent component comprises ethoxyethoxyethanol-tert-butylamine (EEETB)

13. A process according to claim 10 in which the primary absorbent component comprises a combination of (i) an etheramine alcohol of the formula: 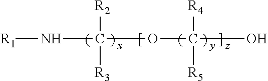
where R², R³, R⁴ and R⁵ are H, R¹ is C3-C8 branched chain alkyl, x and y are each 2 and z is 2 with (ii) a diamino ether of the formula: 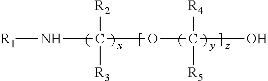
where R², R³, R⁴ and R⁵ are H, R¹ is C3-C8 branched chain alkyl, x and y are each 2 and z is 2.

14. A process according to claim 13 in which the diamino ether comprises 1,2-bis-(tertiarybutylaminoethoxy) ethane.

15. A process according to claim 1 in which the primary absorbent component comprises a compound of the formula: 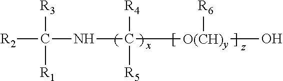
where R¹=R²=R³=C₁-C₄ alkyl; R⁴=R⁵=R⁶=H; x=y=2 and z=2.

16. A process according to claim 15 in which R¹=R²=R³=CH³.

17. A process according to claim 1 in which the primary absorbent component comprises a reaction product of an alkoxy-triethylene glycol and a sterically hindered amine of the formula R²R⁵NH where R² is C₃-C₆ alkyl, R⁵ is H or C₁-C₆ alkyl.

18. A process according to claim 17 in which R² is C₃-C₆ branched chain alkyl.

19. A process according to claim 18 in which the sterically hindered amine is tert-butylamine.

20. A process according to claim 17 in which the alkoxy-triethylene glycol is methoxy-triethylene glycol.

21. A process according to claim 13 in which the primary liquid amine absorbent comprises methoxyethoxyethoxyethanol-tert-butylamine.

22. A process according to claim 1 in which the absorbent combination of the primary absorbent component and the secondary absorbent component is present as an aqueous solution.

23. A process according to claim 1 in which the primary absorbent component and the secondary absorbent component are present in the absorbent combination in a molar ratio from 50:50 to 5:95, respectively.

24. A process according to claim 1 in which the primary absorbent component and the secondary absorbent component are present in the absorbent combination in a molar ratio from 50:50 to 95:5, respectively.

25. A process according to claim 1 in which the primary liquid amine absorbent and the secondary liquid amine absorbent comprise EETB and MEETB.
